(19) United States
(12) Patent Application Publication
(10) Pub. No.: US 2014/0205212 A1
(43) Pub. Date: Jul. 24, 2014

(54) LINER BAG FOR FEMININE HYGIENE WASTE RECEPTACLES

(71) Applicant: THE SCENSIBLE SOURCE CO., LLC, Pittsford, NY (US)

(72) Inventors: John W. Germanow, Pittsford, NY (US); Ann D. Germanow, Pittsford, NY (US)

(73) Assignee: THE SCENSIBLE SOURCE CO., LLC, Pittsford, NY (US)

(21) Appl. No.: 14/219,959

(22) Filed: Mar. 19, 2014

Related U.S. Application Data
(63) Continuation of application No. 12/082,537, filed on Apr. 11, 2008, now Pat. No. 8,690,429.
(60) Provisional application No. 60/922,790, filed on Apr. 11, 2007.

(51) Int. Cl. B65F 1/00

(52) U.S. Cl. CPC B65F 1/0006; B65F 1/0026
USPC 383/22

(57) ABSTRACT

An improved receptacle liner bag is formed of two layers of thin flexible stretchable plastic sheets which are sealed along the sides and bottom, but are unsealed along the top of the bag. The sheets are die-cut to form a framed opening which defines a band between the sides and the top of the bag. When the bag is placed in the receptacle, the band may be disposed around the outside of the sides of the receptacle and stretched over the base of the receptacle so as to provide a hold-down for the bag in the receptacle. The sheets may be perforated along a line below the framed opening. The line, when opened, forms an auxiliary band which can be stretched over and placed behind a hinge of a lid of the receptacle to secure the back of the liner bag in the receptacle.

Priority is claimed to U.S. Provisional Patent Application No. 60/922,790, filed Apr. 11, 2007, which is herein incorporated by reference.

### FIELD OF THE INVENTION

The present invention relates to apparatus (and method) for the sanitary disposal of feminine hygiene products after use thereof, and particularly to a liner bag for feminine hygiene waste receptacles which receive such products.

### BACKGROUND OF THE INVENTION

Women's restrooms are equipped with waste receptacles for sanitary napkins and other feminine hygiene products. These receptacles are boxes of metal or plastic having a lid provided by a cover. The back of the receptacle is attached to a wall of the stall. The lid is hinged to the back wall of the receptacle. Sides of the lid may form a skirt which extends over the top of the receptacle and the front and the sides thereof These receptacles receive a bag therein and may be called surface mounted sanitary napkin disposal units.

Heretofore waxed bags, which may be of waxed paper, were inserted into the receptacle. These bags are prone to being pushed down into the receptacle as the bags are filled with the feminine hygiene products. The sides of the bag may become displaced from the insides of the receptacle or may be pushed down into the receptacle. When this occurs, the feminine products may fall between the outside of the bag and the inside walls of the receptacle, or are placed against the unprotected walls of the receptacle. This creates unsanitary conditions, since the waxed paper bag, when pushed down into the receptacle or away from the walls thereof, loses its effectiveness as a sanitary container.

### SUMMARY OF THE INVENTION

Accordingly, it is an object of the present invention to provide an improved apparatus and method which facilitates the disposal of sanitary products, such as sanitary napkins and other feminine hygiene products.

It is another object of the present invention to provide liner bags which fit within a receptacle and are secured alongside the inner walls thereof to prevent the sanitary products which are inserted therein from falling between the inner walls of the receptacle and the bag.

It is a further object of the present invention to provide an improved liner bag for feminine hygiene waste receptacles, which when installed in the receptacle define a stretchable wrapping band which loops around the receptacle over the base thereof to hold the bag securely in the receptacle.

It is a still further object of the present invention to provide a liner bag for feminine hygiene waste receptacles having a lid where the bag forms an auxiliary band which extends over the lid and against an area, where the lid joins and may be hinged to a back wall of the receptacle for securing the bag against the inside back wall of the receptacle.

Briefly described, the invention provides an improved receptacle liner bag, especially suitable for surface mounted sanitary napkin disposal units. The bag is formed of two layers of thin flexible, stretchable plastic sheets which are sealed along the sides and bottom, but are unsealed along the top of the bag. The sheets are die-cut to form a framed opening which defines a band between the sides and the top of the bag. Since the bag is made of flexible stretchable plastic material, the band along the sides and top of the framed opening can be stretched around the receptacle. Accordingly, when the bag is placed in the receptacle, the band may be disposed around the outside of the sides of the receptacle and stretched over the base of the receptacle so as to provide a hold-down for the bag in the receptacle. The bag may not only line the receptacle, but also provide a flap or skirt which extends over the side and front walls of the receptacle. The flap and the hold-down prevent any used feminine hygiene product which may be placed into the bag from pushing the bag away from the insides of the walls of the receptacle and enter between the receptacle and the bag. The liner bag is therefore an efficient and effective sanitary napkin and other feminine hygiene product disposal device.

In a preferred embodiment of the invention, the sheets are slit along a line below the bottom of the frame forming opening. This slit may be provided by a line of perforations. The slit defines an auxiliary band between the bottom of the opening and the line of perforations. This auxiliary band is placed behind the lid of the receptacle by passing the lid through the slit, provided by the perforations. This band is stretchable to secure the bag against the back wall of the receptacle which is mounted on the wall of the stall or toilet room.

The invention also provides a method for installing a liner bag in a receptacle having the steps of: providing a bag of flexible material having a first end which is closed and a second end having an opening that forms a band; locating the bag in a receptacle having a bottom, and stretching the band to loop around the bottom exterior of the receptacle to retain the bag upright in the receptacle. The locating step may extend flaps over the rim of the receptacle, in which the bag provides such flaps along the bottom of the opening that forms the band. The method may further have the step of locating a second band around the lid of the receptacle, in which the bag has another opening at its first end providing such second band.

The foregoing and other objects features and advantages of the invention as well as a presently preferred embodiment thereof will become apparent from the accompanying drawings.

### BRIEF DESCRIPTION OF THE DRAWINGS

FIG. 1 is a plan view of a liner bag provided in accordance with the invention which is especially adapted to provide a disposable bag into which used feminine hygiene products are received when the bag is inserted into a receptacle, and especially a receptacle of a surface mounted sanitary napkin disposal unit;

FIGS. 2A, 2B, 2C, and 2D are respectively perspective views from the left side, the right side, the back (with the lid of the receptacle closed), and from the bottom of a surface mounted disposal unit wherein the liner bag provided in accordance with the invention is installed into the receptacle of the surface mounted unit;

FIG. 2E is a perspective view from the front with the lid open showing the bag installed in the receptacle;

FIG. 2F is a perspective view from the front showing the bag installed in the receptacle with the lid closed;

FIGS. 3A and 3B are perspective views of the surface mounted unit receptacle with the liner bag provided by the invention in process of being installed, and specifically at the stage where the bag is partially inserted into the receptacle of the unit, FIG. 3A being from the left side and FIG. 3B from the right side of the unit respectively; and

FIGS. 4A, 4A′, 4B, 4B′, 4C, and 4D are perspective views showing the liner bag provided by the invention in the process of installation into a receptacle and showing the auxiliary band formed when the liner perforations are opened to provide a slit, installed partially across the lid and the loop of the band which stretches around the sides and over the bottom of the receptacle lying across the sides and face of the receptacle, FIG. 4A and A′ being taken from the left side, FIGS. 4B and 4B′ being taken from the right side, FIG. 4C being taken from the back with the lid being pivoted on the hinge, which attaches the lid to the back of the receptacle, in a partially open position to show the auxiliary band being stretched across the lid toward the joint formed by the hinge, and with FIG. 4D being taken from the front of the receptacle with the lid opened and the auxiliary band being pushed over the lid.

### DETAILED DESCRIPTION OF THE INVENTION

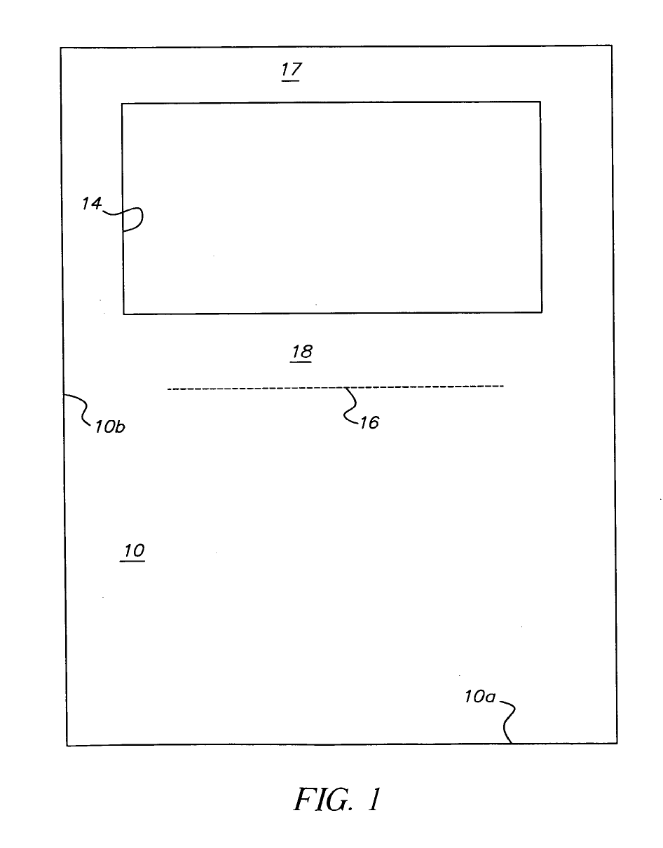

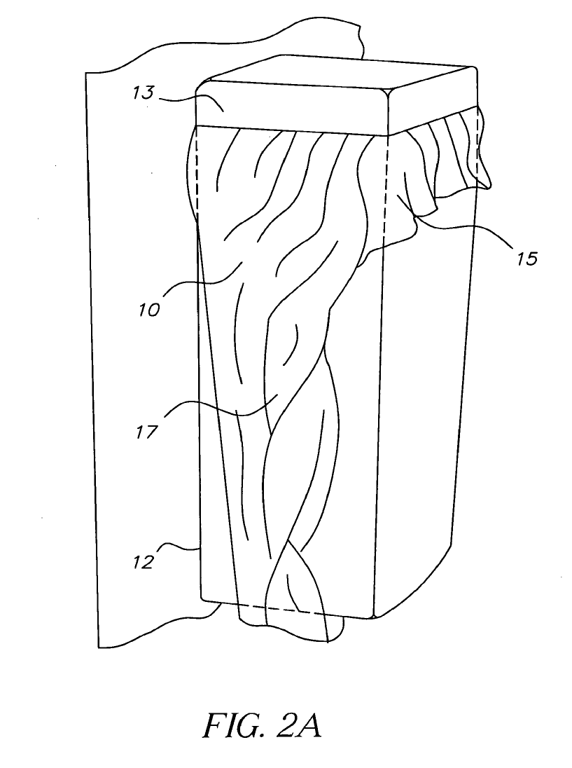

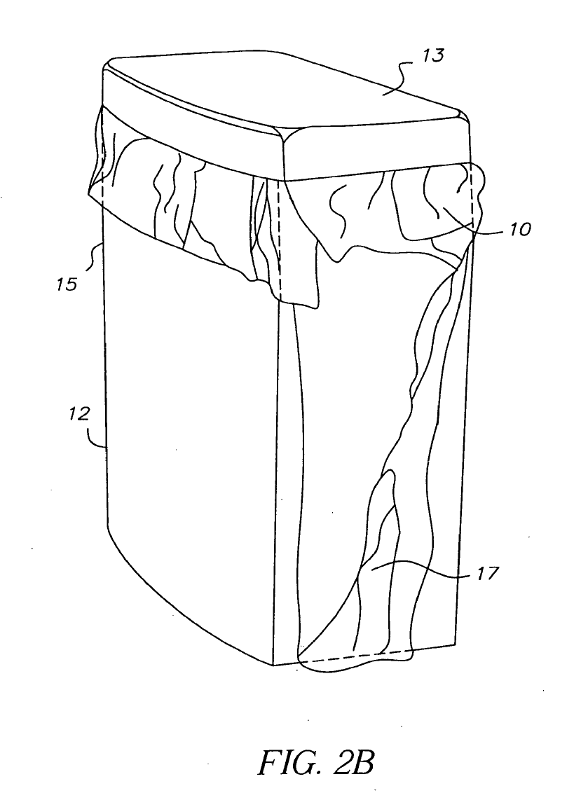

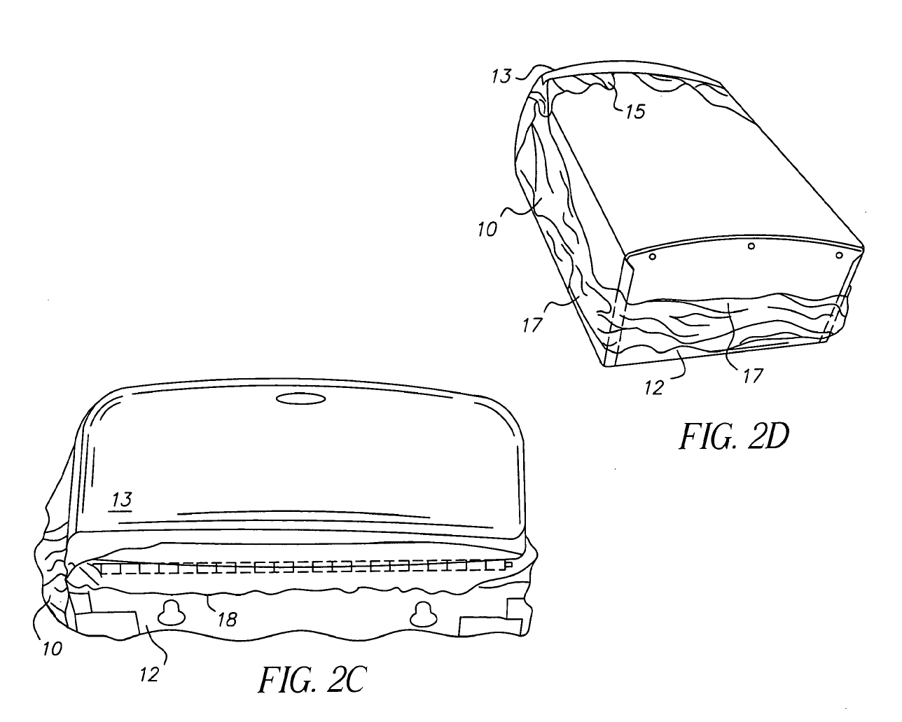

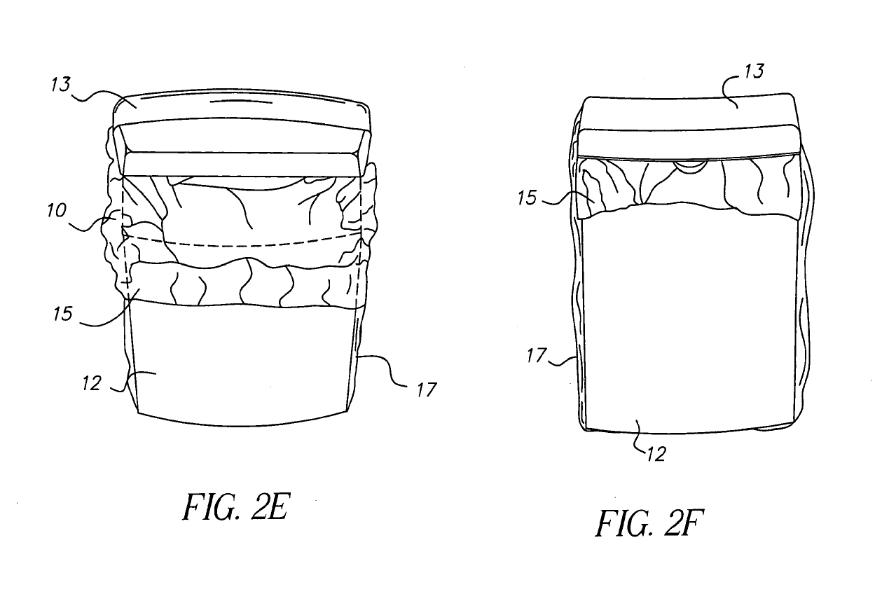

Referring to the drawing, the bag (10) itself is a plastic bag (see FIG. 1) preferably of low density, 1 mil. thick low density polyethylene material. Bag (10) is formed of two layers of thin flexible stretchable plastic sheets which are sealed along the sides and bottom to provide a closed end (10a), and unsealed along a length of a top end (10b). The bag is long enough to fill the receptacle (12) to the bottom thereof. The bag (10) is, by virtue of the material thereof flexible and stretchable, facilitates insertion thereof into the receptacle with a flap (15) or skirt extending around the top of the receptacle (see FIGS. 2 A-D). In order to form the band (17) which holds the bag (10) inside the receptacle and also to form the flap, the bag is made longer than the side walls of the receptacle. For example, the receptacle may be 10″ in height above the base and have an opening 8″ long and 4″ wide. In other words, the depth of the receptacle, from the front wall to the back wall thereof which is mounted on the wall of the stall, is 4″, approximately. The bag is provided (by die-cutting the sheets forming such bag) with a die-cut opening (14) providing a frame which forms the band (17) around the sides and top of the opening. The top of the opening is the top of the band. The opening is of a size sufficient to leave an area for the flap below the bottom of the opening. For example, for a 10″ high receptacle, the frame around the sides and top of the opening may be an inch and a half in width and the bottom of the opening may be 14″ above the bottom of the bag. This leaves an area sufficient to form the flap.

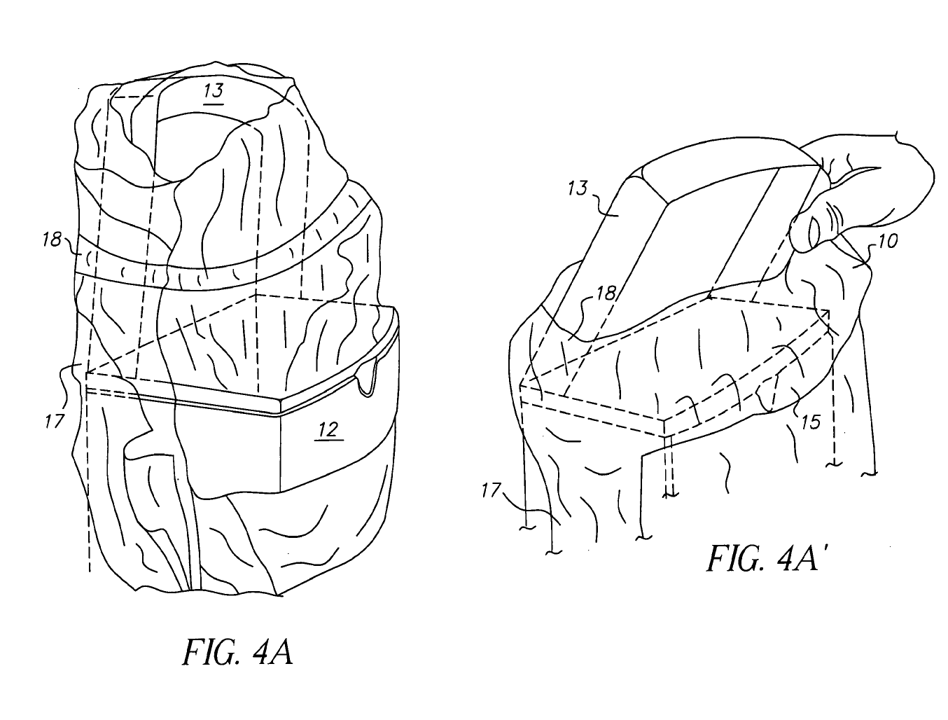

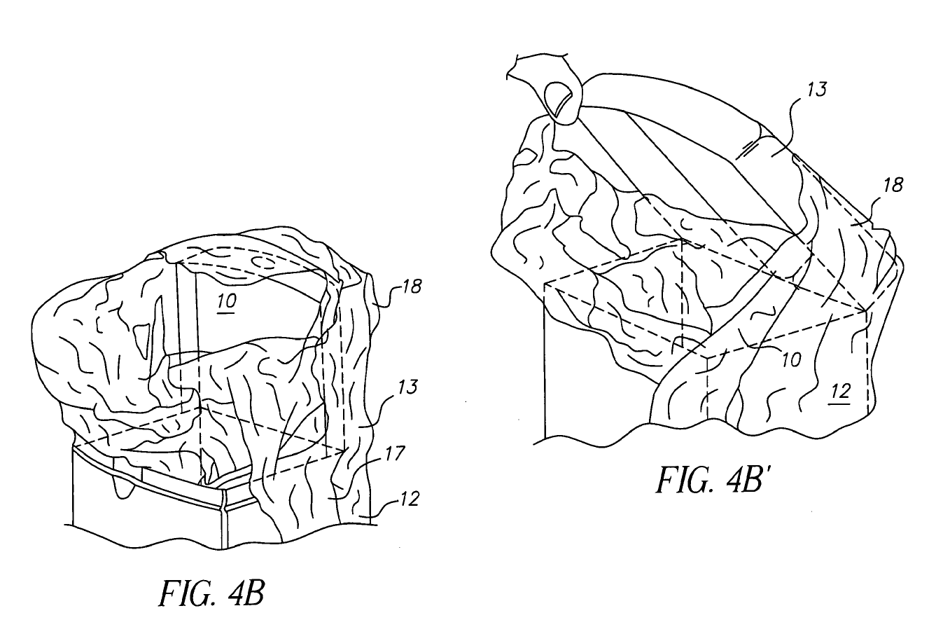

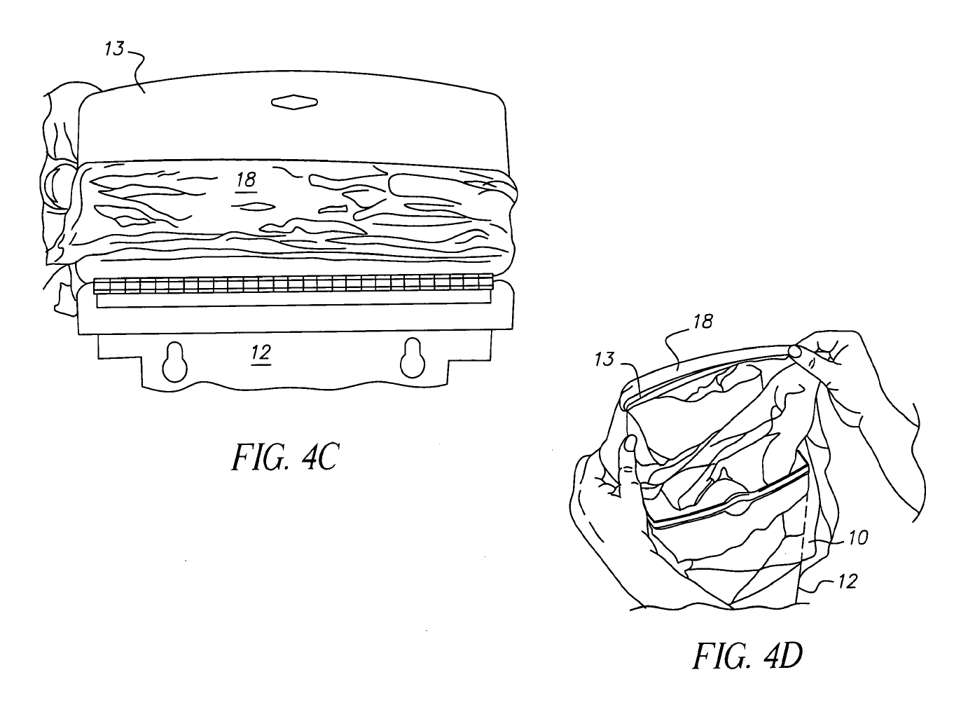

In order to form an auxiliary band, which extends over and behind the lid (13) of the receptacle (12) and secures the back of the inserted bag (10) inside the receptacle and further eliminates any space between the edge of the back of the bag and the inside back wall of the receptacle, a slit is formed by a line of perforations (16). This slit defines, between the bottom of the opening (14) and the line (16), an auxiliary band (18). This auxiliary band (18) is formed when the perforations are opened to provide the slit upon insertion of the band (18) onto the lid (13) of the receptacle (12) as best shown in FIGS. 4A, B, C and D. The use of this auxiliary band (18) is preferred but is optional.

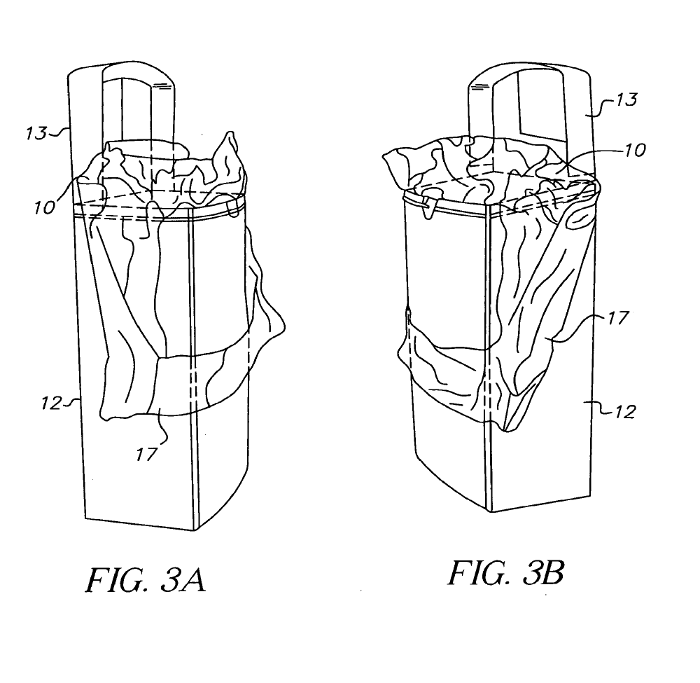

When the bag (10) is inserted into the receptacle (see FIGS. 3 and 4), the backside of the flap bears against the inside back wall of the housing. The band (17) which is formed along the outsides of the opening and along the top of the opening, which may, in the above example, be approximately 1½″ in width and can be extended over the top edge of the receptacle while the flap is formed over the front wall and the side walls of the receptacle. The band (17) is long enough to be brought around the sides of the receptacle (12) and around the base of the receptacle. The length of the band (17) is approximately the same as the length of the receptacle so that it can stretch and provide a tight fit, thereby retaining the bag and its flaps in the receptacle. The flexible, stretchable material of the bag (10) allows the band (17) to be stretched along the outside, side walls of the receptacle (12) and around and against the base of the receptacle. As the bag (10) is filled with sanitary napkin and other feminine hygiene product waste, the bag thus maintains its installed position (e.g., upright) in the receptacle (12).

Preferably, the plastic material of the bag (10) includes bio-degradable plastic additive which enables the bag to bio-degrade when disposed of in a sanitary landfill.

Preferably, the bag material contains an antimicrobial agent which inhibits the growth of odor causing bacteria.

The bag material may contain fragrance materials to mask odors and can also provide a fresh floral smell. The bag (10) may be made with or without bio-degradable plastic additive and with or without antimicrobial or fragrance agents.

Another feature of the invention is that the band (17) and auxiliary band (18) facilitate the removal of the bag (10) after it is full, so that the bag may be disposed of together with the used feminine hygiene products contained therein. The band (17) may be slipped off the bottom of the receptacle (12) and the auxiliary band (18), if present, may be slipped off around the lid (13). Then the bag (10) may be lifted out of the receptacle (12) with the aid of the band (17) and the auxiliary band (18). The band (17) may be tied into a knot or with a tie, to close the bag (10) and prevent the used feminine hygiene products from falling out of the bag after it is removed from the receptacle (12).

From the foregoing description, it will be apparent that an improved receptacle liner bag and method for using such bag has been provided. Variations and modifications of the herein described receptacle liner bag and other applications for the invention will undoubtedly suggest themselves to those skilled in the art. Accordingly, the foregoing description should be taken as illustrative and not in a limiting sense.

1. A liner bag for a feminine hygiene waste receptacle comprising:
two layers of stretchable thin material which are sealed along sides and bottom edges to provide a closed bottom end, and unsealed along an open top end, in which said top end has two opposing sides; and
a band having two ends each extending from a different one of said two opposing sides of said open top end, and said band being stretched downwards to located said band along exterior sides and base of a receptacle during installation of the bag as a liner for the receptacle, wherein said band is of a length selected in accordance with a length of the receptacle to received said bag so that said band fits under said base of the receptacle to retain said bag upright in the receptacle.

2. The liner bag according to claim 1 wherein said bag further comprises flaps of said layers extending along the perimeter of said open top end, and said flaps extend over a top rim of said receptacle during installation of the bag as a liner for the receptacle.

3. The liner bag according to claim 1 wherein said open top end of said bag is of sufficient length from said closed bottom end of the bag to define flaps which extend over said receptacle away from a rim along a top edge of the receptacle.

4. The liner bag according to claim 1 wherein the band is sufficiently long to be knotted upon removal of the bag from the receptacle filled with feminine hygiene waste.

5. The liner bag according to claim 1 wherein said bag is of biodegradable material.

6. The liner bag according to claim 1 wherein said bag is of material having an antimicrobial agent.

7. The liner bag according to claim 1 wherein said bag is of scented material.

8. A method for installing a liner bag in a receptacle comprising the steps of:
providing a bag of flexible material having a first end which is closed and a second end having an opening that forms a band of a length selected exclusively for use of said band to fit under a bottom of the receptacle;
locating said bag in the receptacle having a bottom; and
stretching said band to tightly fit at least around the bottom of said receptacle to retain said bag upright in the receptacle.

9. The method according to claim 8 wherein receptacle has a rim, and said method further comprises extending said layers over said rim while separating said layers so that said bag provides flaps along a bottom of said opening, and said locating step further comprises extending the flaps over the rim of the receptacle.

10. The method according to claim 8 further comprising the step of locating a portion of the bag over a rim of the receptacle when said bag is located in the receptacle.

11. The method according to claim 8 wherein said bag is of material which is one or more of biodegradable, antimicrobial, or scented.

12-17. (canceled)

18. The liner bag according to claim 1 wherein said length of said band is selected exclusively for said band to tightly fit under the base of the receptacle to retain said bag upright.

19. The liner bag according to claim 1 wherein said band provide means for lifting said bag with said feminine hygiene waste contained therein from the receptacle when said band is slipped off from being stretched around the base of the receptacle.

20. The liner bag according to claim 19 wherein said bag is closed by said band being tied into a knot or with a tie to prevent feminine hygiene waste contained therein from falling out of the bag when removed from the receptacle.

21. The liner bag according to claim 1 wherein said length of the band is selected approximately the same as the length of the receptacle.

22. The liner bag according to claim 1 wherein said band consists of a single band of both of said layers.

23. The method according to claim 8 wherein said step of providing a bag further provides said length of the band being selected approximately the same as the length of the receptacle.

24. The method according to claim 8 further comprising the steps of slipping said band from the bottom of the receptacle, and utilizing said band to lift said bag with said feminine hygiene waste contained therein from the receptacle.

25. The method according to claim 24 further comprising the step of closing said bag with said band being tied into a knot or with a tie to prevent feminine hygiene waste from falling out of the bag.

26. A waste disposal unit having a liner comprising:
a receptacle having an upper opening with a rim, a closed bottom, and sides extending between said upper opening and said closed bottom;
a bag having an a lower contents receiving portion, and an upper band forming a loop with ends connected to said lower contents receiving portion, and a skirt or flap along the top of the lower contents receiving portion, in which said lower contents receiving portion of said bag is located in said receptacle with said skirt or flap extending over the rim of said receptacle, and said band is stretched downwards to located said band along the sides of the receptacle and under the bottom of said receptacle; and
said band is of a length approximately equal to a length of the receptacle so that said stretched band tightly fits under said base of the receptacle to retain said bag upright in the receptacle.

27. The waste disposal unit according to claim 26 wherein said band provides means for lifting said bag with said contents contained therein from the receptacle when said band is slipped off from being stretched under the base of the receptacle.
